(19) United States
(12) Patent Application Publication
(10) Pub. No.: US 2014/0152430 A1
(43) Pub. Date: Jun. 5, 2014

(54) APPARATUS AND METHODS TO PROVIDE ACCESS TO APPLICATIONS IN AUTOMOBILES

(71) Applicant: HONDA MOTOR CO., LTD., Tokyo (JP)

(72) Inventor: Eric Ohki, Rancho Palos Verdes, CA (US)

(73) Assignee: HONDA MOTOR CO., LTD., Tokyo (JP)

(21) Appl. No.: 13/706,030

(22) Filed: Dec. 5, 2012

(51) Int. Cl. B60Q 11/00

(52) U.S. Cl. CPC B60Q 11/00
USPC 340/425.5

(57) ABSTRACT

A computing device for use in an automobile is provided. The computing device includes a communication interface that is configured to receive data for at least one user-selected application. At least one processor is coupled to the communication interface. The at least one processor is programmed to identify when the automobile is in a first operational mode, wherein the automobile is in the first operational mode while the automobile is moving. The at least one processor is also programmed to identify when the automobile is in at least one second operational mode, wherein the automobile is in the second operational mode when the automobile is not moving or stopped. Moreover, the at least one processor is programmed to execute the user-selected application when the second operational mode identified such that a user of the automobile is enabled to access the user-selected application during the second operational mode.

### BACKGROUND

The field of the disclosure relates generally to automobiles and, more particularly, to a computing device for use in an automobile that provides access to user-selected applications during various operational modes of the automobile.

At least some known vehicles, such as automobiles, include navigation systems therein for use by operators and/or passengers of the vehicles. For example, at least some known automobiles, may include a satellite-based navigation system that acquires positional data from a database to enable a location of the user on a road can be identified. However, such systems are limited to providing navigational information. For example, such systems are unable to provide information accessible via the internet including media information and/or user-selected applications, such as Facebook® or YouTube®. (Facebook is a registered trademark of Facebook, Inc. of Palo Alto, Calif. and YouTube is a registered trademark of Google, Inc. of Mountain View, Calif.) Accordingly, the user of the automobile may become bored or disinterested, especially when the automobile is in a stop mode or park mode.

As a result, many users may use handheld devices in automobiles, such as smart phones, to access media information and/or user-selected applications in their automobiles. However, using such handheld devices can be dangerous while driving, as the use may be distracting to the driver. Moreover, many states have enacted laws that prohibit the use of such devices while driving automobiles. Some automobiles may include devices, such as a heads-up display (HUD) or a human-machine-interface (HMI) that provides access to the internet. However, such devices are unable to selectively provide access to such information. For example, such devices may provide information to the user at all times regardless of the operational mode of the automobile. Moreover, a driver may be distracted if he or she is able to access the internet while driving. Accordingly, having access to such information at all times can be dangerous.

### BRIEF DESCRIPTION

In one embodiment, a computing device for use in an automobile is provided. The computing device includes a communication interface that is configured to receive data for at least one user-selected application. At least one processor is coupled to the communication interface. The at least one processor is programmed to identify when the automobile is in a first operational mode, wherein the automobile is in the first operational mode while the automobile is moving. The at least one processor is also programmed to identify when the automobile is in at least one second operational mode, wherein the automobile is in the second operational mode when the automobile is stopped. Moreover, the at least one processor is programmed to execute the user-selected application when the second operational mode identified such that a user of the automobile is enabled to access the user-selected application during the second operational mode.

In another embodiment, an automobile is provided. The automobile includes at least one console and a computing device that is coupled to the console. The computing device includes a communication interface that is configured to receive data for at least one user-selected application. At least one processor is coupled to the communication interface and programmed to identify when the automobile is in a first operational mode, wherein the automobile is in the first operational mode while the automobile is moving. The at least one processor is also programmed to identify when the automobile is in at least one second operational mode, wherein the automobile is in the second operational mode when the automobile is stopped. Moreover, the at least one processor is also programmed to execute the user-selected application when the second operational mode identified such that a user of the automobile is enabled to access the user-selected application during the second operational mode.

In yet another embodiment, a method of providing access to at least one user-selected application in an automobile is provided. Data for the at least one user-selected application is received, via a communication interface. The method also includes identifying when the automobile is in a first operational mode, via at least one processor, wherein the automobile is in the first operational mode while the automobile is moving. Moreover, the method includes identifying when the automobile is in at least one second operational mode, via the at least one processor, wherein the automobile is in the second operational mode when the automobile is stopped. The user-selected application is executed when the second operational mode is identified such that a user of the automobile is enabled to access the user-selected application during the second operational mode.

### BRIEF DESCRIPTION OF THE DRAWINGS

FIG. 1 is a block diagram of an exemplary automobile; and

FIG. 2 is a block diagram of an exemplary computing device that may be used with the automobile shown in FIG. 1.

### DETAILED DESCRIPTION

The exemplary systems, apparatus, and methods described herein overcome at least some disadvantages of known devices and systems that enable information to be provided to users of automobiles. More specifically, the embodiments described herein include a computing device for use in an automobile that enables selective access to user-selected applications during various operational modes of the automobile. As such, in addition to navigational information, the computing device enables access to other types of information, such as user-selected applications. Moreover, since the computing device enables access to the applications based on the various operational modes of the automobile, the user is able to access such applications only during times when such applications would not be deemed a distraction to a driver, such as when the automobile is not moving or stopped. As such, distractions and/or dangers while operating the automobile may be inhibited.

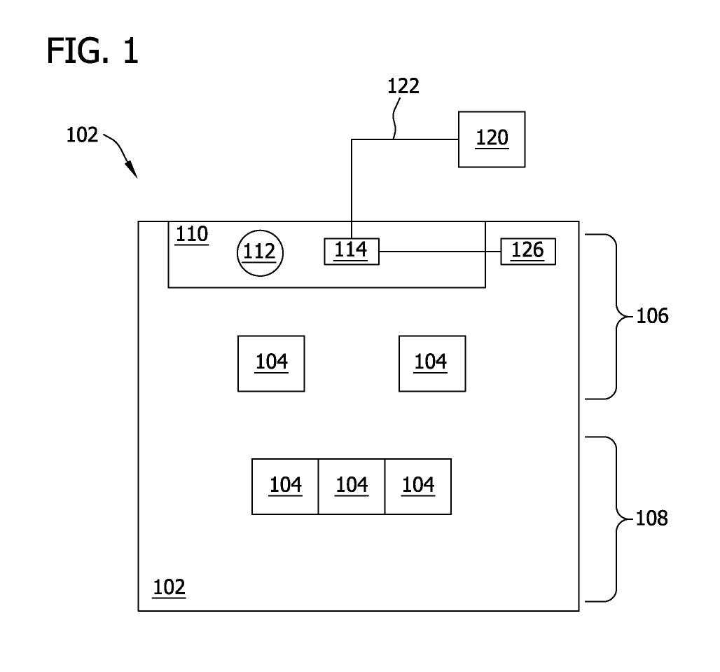

FIG. 1 illustrates an automobile 102. It should be noted that the term “automobile” refers generally to an autocar, motor car, or car that is a wheeled motor vehicle that may be used for transporting passengers and that carries its own engine or motor (not shown). For example, the automobile may include a gasoline engine or an internal combustion engine that uses gasoline to enable the automobile to move. The automobile may also be an electric automobile that includes one or more electric motors (not shown) that are used to provide propulsion to the automobile. Energy, such as electrical energy, used to propel automobiles may come from various sources, such as, but not limited to, an on-board rechargeable battery and/or an on-board fuel cell. In one embodiment, the electric automobile may be a hybrid automobile that captures and stores energy generated by braking. Moreover, a hybrid electric automobile may use energy stored in an electrical source, such as a battery, to continue operating when idling to conserve fuel. Some hybrid electric automobiles are capable of recharging the battery by plugging into a power receptacle, such as a general power outlet. Another example of an electric automobile is a fuel-cell vehicle, which uses only electrical energy for propulsion.

In the exemplary embodiment, automobile 102 is a sedan that includes at least one seat 104. More specifically, automobile 102 includes five seats 104, with two seats 104 positioned in a front portion 106 of automobile 102 and three seats 104 positioned in a rear portion 108 of automobile 102. Moreover, at least one console 110 is positioned in automobile front portion 106. Alternatively, console 110 may be positioned in any other portion of automobile 102. In the exemplary embodiment, a steering wheel 112 is coupled to console 110. It should be noted that, as used herein, the term “couple” is not limited to a direct mechanical, electrical, and/or communication connection between components, but may also include an indirect mechanical, electrical, and/or communication connection between multiple components.

In the exemplary embodiment, a computing device 114 is also coupled to console 110. Alternatively, computing device 114 may be positioned in any other portion of automobile 102 that enables computing device 114 to function as described herein. Computing device 114, in the exemplary embodiment, is coupled to a remote server 120 via a network 122 such that server 120 may communicate with computing device 114. In the exemplary embodiment, server 120 is a hardware system, such as a computer, that is configured to perform various computational tasks for various programs or clients. More specifically, server 120 is configured to run one or more services as a host to serve the needs of the users of computing device 114. For example, in the exemplary embodiment, server 120 may be an application server to run various software or user-selected applications. Server 120 may also be a database server, a file server, a mail server, a print server, a web server, or any other type of server that enables computing device 114 and/or automobile 102 to function as described herein.

In the exemplary embodiment, network 122 may include, but is not limited to only including, the Internet, a local area network (LAN), a wide area network (WAN), a wireless LAN (WLAN), a mesh network, and/or a virtual private network (VPN). In the exemplary embodiment, server 120 may communicate with automobile 102 using a wired network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. (WIMAX is a registered trademark of WiMax Forum, of Beaverton, Oreg. IEEE is a registered trademark of the Institute of Electrical and Electronics Engineers, Inc., of New York, N.Y.)

Computing device 114 is also coupled to various portions of automobile 102, such as an engine (not shown) of automobile 102, via an automobile communication module 126. In the exemplary embodiment, automobile communication module 126 enables computing device 114 to receive information regarding automobile 102. More specifically, module 126 enables computing device 126 to receive information regarding various operational modes of automobile 102, wherein one operational mode is when automobile 102 is moving and another operational mode is when the automobile 102 is not moving or stopped. In the exemplary embodiment, the operational mode when automobile 102 is moving may include a driving mode that includes automobile 102 moving in a particular direction. In the exemplary embodiment, the operational modes of automobile 102 when automobile 102 is not moving or stopped may include, but are not limited to, a start mode that includes a start up of the engine of automobile 102 and a stop mode that includes a shut down of the engine of automobile 102. The stop mode may also include automobile 102 being in a braked position while the engine is still on. Another example of a non-moving or stopped operational mode of automobile 102 is a park mode that includes automobile 102 being in a stationary position while the engine is still on. In the park mode, automobile 102 is shifted into a parked position as opposed to automobile 102 being in a braked position. Alternatively, computing device 114 may receive any other information regarding automobile 102 that enables computing device 114 to function as described herein.

During operation, the engine for automobile 102 is initiated and automobile 102 is in a start mode. Communication module 126 transmits a signal representative of automobile 102 being in a start mode to computing device 114. As explained in more detail below, when computing device 114 identifies that the automobile is in the start mode, computing device 114 retrieves data for at least one user-selected application from server 120. Computing device 114 then executes the application(s) such that the user of automobile 102 is enabled to access the application(s) during the start mode of automobile 102. For example, the user may have access to web based applications, such as Facebook® while automobile 102 is in the start mode. Alternatively, computing device 114 may have previously retrieved data from server 120 such that the data may be stored within computing device 114. Computing device 114 then executes the application(s) when computing device 114 identifies that automobile 102 is in the start mode.

In the exemplary embodiment, when automobile 102 changes from the start mode to a drive mode, communication module 126 transmits a signal to computing device 114 representative of automobile 102 being in the drive mode. As explained in more detail below, when computing device 114 identifies that automobile 102 is in the drive mode, computing device 114 disables the application(s) and the user no longer has access to the application(s) while the automobile 102 is in the drive mode. In the exemplary embodiment, computing device 114 executes the application(s) during the start mode, stop mode, and/or park mode. Computing device 114 disables access to the applications during the drive mode. Alternatively, computing device 114 may execute or disable applications during any operational mode of automobile 102.

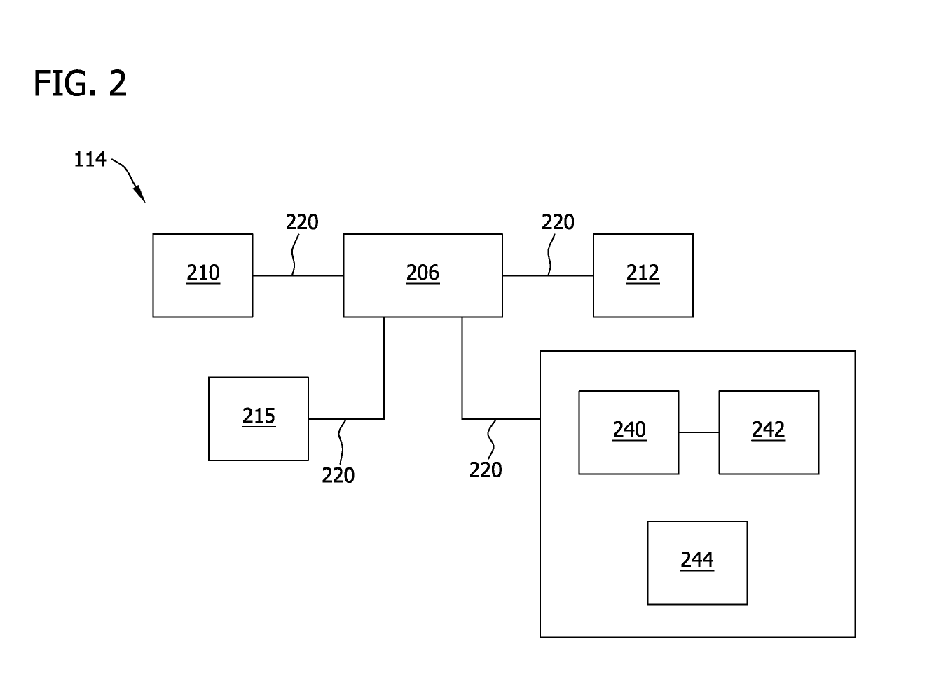

FIG. 2 is a block diagram of computing device 114. In the exemplary embodiment, computing device 114 includes at least one processor 206 that is coupled to a communication interface 210, to a memory device 212, to a presentation interface 214, and to a user interface 215 via a system bus 220. In the exemplary embodiment, communication interface 210 is coupled to server 120 (shown in FIG. 1) via network 122. Communication interface 210 is configured to receive data for at least one user-selected application, such as, for example, Facebook®. Moreover, in the exemplary embodiment, communication interface 210 is coupled to automobile 102 (shown in FIG. 1) via automobile communication module 126 (shown in FIG. 1).

In the exemplary embodiment, processor 206 is coupled to communication interface 210 to enable programmed instructions to be executed. In some embodiments, executable instructions are stored in memory device 212. In the exemplary embodiment, computing device 114 is programmed to perform one or more operations described herein by programming processor 206. For example, processor 206 may be programmed by encoding an operation as one or more executable instructions and providing the executable instructions in memory device 212. Processor 206 may include one or more processing units (e.g., in a multi-core configuration).

In the exemplary embodiment, processor 206 is programmed to identify when automobile 102 is in various operational modes, wherein one of the operational modes is when automobile 102 is moving and another mode is when automobile 102 is not moving or stopped. For example, processor 206 may be programmed to identify when automobile 102 a driving mode, a start mode, a stop mode, and/or a park mode. Processor 206 is further programmed to access at least one application from memory device 212 and execute the application when a non-moving operational mode is identified. For example, in the exemplary embodiment, processor 206 is programmed to access and execute at least one user-selected application when automobile 102 is in a start mode, stop mode, and/or park mode. In one embodiment, stopped may refer to a standstill by automobile 102 or parked. Processor 206 is programmed to execute the application to perform the function of the application. Moreover, in the exemplary embodiment, processor 206 is programmed to disable the execution of the user-selected application when automobile 102 is in a driving mode. Alternatively, processor 206 may be programmed to execute or disable the user-selected application during various operational modes of automobile 102.

Processor 206 may include, but is not limited to only including, a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by processor 206, cause processor 206 to perform at least a portion of the methods described herein. The above examples are exemplary only, and thus are not intended to limit in any way the definition and/or meaning of the term processor.

Memory device 212 stores information, such as executable instructions and/or other data that is stored and retrieved. Memory device 212 may include one or more computer readable media, such as, without limitation, dynamic random access memory (DRAM), static random access memory (SRAM), a solid state disk, and/or a hard disk. Moreover, in the exemplary embodiment, memory device 212 may include random access memory (RAM), which can include non-volatile RAM (NVRAM), magnetic RAM (MRAM), ferroelectric RAM (FeRAM) and other forms of memory.

Memory device 212 may also include read only memory (ROM), flash memory and/or Electrically Erasable Programmable Read Only Memory (EEPROM). Any other suitable magnetic, optical and/or semiconductor memory, by itself or in combination with other forms of memory, may be included in memory device 212. Memory device 212 may also be, or include, a detachable or removable memory, including, but not limited to, a suitable cartridge, disk, CD ROM, DVD or USB memory. Alternatively, memory device 212 may be a database. The term “database” refers generally to any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.

In the exemplary embodiment, presentation interface 214 presents information, such as an application source code, input events, and/or validation results to a user of automobile 102. In the exemplary embodiment, presentation interface 214 includes a display adapter 240 that is coupled to at least one display device 242. In the exemplary embodiment, display device 242 includes a visual display, such as a cathode ray tube (CRT), a liquid crystal display (LCD), an organic LED (OLED) display, and/or an “electronic ink” display. Moreover, while display device 242 is coupled within presentation interface 214 and a component of computing device 114 in the exemplary embodiment, it should be noted that display device 242 may be a separate component from computing device 114. For example, display device 242 may be a heads up display (HUD) that is coupled within automobile 102 and coupled to computing device 114. Moreover, presentation interface 214 may also include an audio output device 244. For example, audio output device 244 may be a data to simulated voice convertor that may include an audio adapter (not shown) and/or a speaker (not shown) such that the user is enabled to hear information. Alternatively, audio output device 244 may be any other type of device that enables computing device 114 and/or automobile 102 to function as described herein.

In the exemplary embodiment, user interface 215 receives any information suitable for use with the methods described herein. Moreover, in the exemplary embodiment, user interface 215 may include, for example, a keyboard, a pointing device, a mouse, a stylus, a touch sensitive panel (e.g., a touch pad or a touch screen), a gyroscope, an accelerometer, a position detector, and/or an audio input interface (e.g., including a microphone). Alternatively, a single component, such as a touch screen, may function as both a display device of presentation interface 214 and user interface 215.

During operation, the engine (not shown) for automobile 102 is initiated and automobile 102 is in a start mode. Communication module 126 transmits a signal representative of automobile 102 being in the start mode to computing device 114. More specifically, the signal is transmitted to communication interface 210. Processor 206 identifies that automobile 102 is in the start mode and processor 206 transmits a signal, via communication interface 210, to retrieve data for at least one user-selected application from server 120 (shown in FIG. 1). Server 120 transmits the data to communication interface 210 such that the data can be stored in memory device 212. Alternatively, computing device 114 may have previously received the data for storage in memory device 212.

Moreover, when processor 206 identifies that automobile 102 is in the start mode, processor 206 accesses at least one application stored in memory device 212 and executes the application(s) such that a user of automobile 102 has access to the application(s) during the start mode. For example, the user may be able to access Facebook® during the start mode of automobile 104. More specifically, computing device 114 may present the application(s) to the user via presentation interface 214. For example, the user may be able to see a visual display of the login web page for Facebook®. The user may then input at least one unique identifier, such as the login information, via user interface 215.

In one embodiment, computing device 114 may also require the user to input a unique identifier prior to enabling the user to have access to the applications. For example, when automobile 102 is in the start mode and processor 206 identifies the automobile being in the start mode, processor 206 may then prompt the user, via presentation interface 214, to input at least one unique identifier, such as a username and/or password. The user may then input the unique identifier via user interface 215. Processor 206 then verifies the unique identifier and then enables the user to have access to the user-selected application(s).

In the exemplary embodiment, when automobile 102 changes from the start mode to a driving mode, communication module 126 transmits a signal to computing device 114 representative of automobile 102 being in the drive mode. Communication interface 210 receives the signal and processor 206 then identifies that automobile 102 is in the drive mode. Processor 206 ceases running or executing the application(s) and the user is unable to access the application(s) while automobile 102 is in driving mode. In the exemplary embodiment, when automobile 102 changes from the driving mode to a park mode or a stop mode, the user can then access the application(s) again. For example, communication module 126 transmits a signal representative of automobile 102 being in a stop mode or a park mode to computing device 114. More specifically, the signal is transmitted to communication interface 210. Processor 206 identifies that automobile 102 is in the stop mode or the park mode, and processor 206 accesses at least one application stored in memory device 212 and executes the application(s) such that the user again has access to the application(s) during the stop mode or the park mode.

Accordingly, in the exemplary embodiment, the user is able to access such applications during times when the use of such applications would not be deemed a distraction to the driver, such as when automobile 102 is in a start mode, stop mode, or park mode. Computing device 114 disables access to such applications during the drive mode such that distractions and/or dangers while operating automobile 102 may be inhibited. Alternatively, computing device 114 may enable access to or disable access to user-selected applications during various different modes of automobile 102.

As compared to known devices and systems that enable information to be provided to users of automobiles, the embodiments described herein include a computing device for use in an automobile to enable selective access to user-selected applications during various operational modes of the automobile. The computing device includes a communication interface that is configured to receive data for at least one user-selected application. At least one processor is coupled to the communication interface. The at least one processor is programmed to identify when the automobile is in a first operational mode, wherein the automobile is in the first operational mode while the automobile is moving. The at least one processor is also programmed to identify when the automobile is in at least one second operational mode, wherein the automobile is in the second operational mode when the automobile is not moving or stopped. Moreover, the at least one processor is programmed to execute the user-selected application when the second operational mode identified such that a user of the automobile is enabled to access the user-selected application during the second operational mode. Accordingly, in addition to navigation information, the computing device enables access to other types of information, such as user-selected applications. Moreover, since computing device enables access to the applications based on the various operational modes of the automobile, the user is able to access such applications during times when using the applications would not be deemed a distraction, such as when the automobile is in a stop mode or a park mode. As such, distractions and/or dangers while operating the automobile may be inhibited.

A technical effect of the systems, apparatus, and methods described herein includes at least one of: (a) receiving data for at least one user-selected application, via a communication interface; (b) identifying when an automobile is in a first operational mode, via at least one processor, wherein the automobile is in the first operational mode while the automobile is moving; (c) identifying when an automobile is in at least one second operational mode, via at least one processor, wherein the automobile is in the second operational mode when the automobile is not moving or stopped; and (d) executing at least one user-selected application when at least one second operational mode is identified such that a user of the automobile is enabled to access the at least one user-selected application during the at least one second operational mode.

Exemplary embodiments of systems, apparatus, and methods to enable access to user-selected applications in automobiles are described above in detail. The systems, apparatus, and methods are not limited to the specific embodiments described herein, but rather, components of each system, apparatus, and/or steps of each method may be utilized independently and separately from other components and/or steps described herein. For example, each system may also be used in combination with other systems and methods, and is not limited to practice with only systems as described herein. Rather, the exemplary embodiment can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples for the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for use in an automobile, said computing device comprising:
a communication interface configured to receive data for at least one user-selected application; and
at least one processor coupled to said communication interface, said at least one processor programmed to:
identify when the automobile is in a first operational mode, wherein the automobile is in the first operational mode while the automobile is moving;
identify when the automobile is in at least one second operational mode, wherein the automobile is in the at least one second operational mode when the automobile is stopped; and
execute the at least one user-selected application when the at least one second operational mode is identified such that a user of the automobile is enabled to access the at least one user-selected application during the at least one second operational mode.

2. A computing device in accordance with claim 1, comprising a presentation interface coupled to said at least one processor and configured to present the at least one user-selected application to the user.

3. A computing device in accordance with claim 1, comprising a user interface configured to receive at least one input from the user, wherein the at least one input includes at least one unique identifier related to the at least one user-selected application.

4. A computing device in accordance with claim 1, wherein said at least one processor is programmed to identify when the automobile is in the at least one second operational mode when the automobile is in at least one of a start mode, a stop mode, and a park mode.

5. A computing device in accordance with claim 4, wherein said at least one processor is programmed to execute the at least one user-selected application when the automobile is in at least one of the start mode, the stop mode, and the park mode.

6. A computing device in accordance with claim 1, wherein said at least one processor is programmed to identify when the automobile is the first operational mode when the automobile is in a driving mode.

7. A computing device in accordance with claim 6, wherein said at least one processor is programmed to disable the at least one user-selected application when the automobile is in the driving mode such that the user is unable to access the at least one user-selected application during the driving mode.

8. An automobile comprising:
at least one console; and
a computing device coupled to said at least one console, said computing device comprising:
a communication interface configured to receive data for at least one user-selected application; and
at least one processor coupled to said communication interface and programmed to:
identify when said automobile is in a first operational mode, wherein said automobile is in the first operational mode while the automobile is moving;
identify when the automobile is in at least one second operational mode, wherein the automobile is in the at least one second operational mode when the automobile is stopped; and
execute the at least one user-selected application when the at least one second operational mode is identified such that a user of the automobile is enabled to access the at least one user-selected application during the at least one second operational mode.

9. An automobile in accordance with claim 8, wherein said computing device comprises a presentation interface coupled to said at least one processor and configured to present the at least one user-selected application to the user.

10. An automobile in accordance with claim 8, wherein said computing device comprises a user interface configured to receive at least one input from the user, the at least one input includes at least one unique identifier related to the at least one user-selected application.

11. An automobile in accordance with claim 8, wherein said at least one processor is programmed to identify when said automobile is in the at least one second operational mode when said automobile is in at least one of a start mode, a stop mode, and a park mode.

12. An automobile in accordance with claim 11, wherein said at least one processor is programmed to execute the at least one user-selected application when said automobile is in at least one of the start mode, the stop mode, and the park mode.

13. An automobile in accordance with claim 8, wherein said at least one processor is programmed to identify when said automobile is the first operational mode when said automobile is in a driving mode.

14. An automobile in accordance with claim 13, wherein said at least one processor is programmed to disable the at least one user-selected application when said automobile is in the driving mode such that the user is unable to access the at least one user-selected application during the driving mode.

15. A method of providing access to at least one user-selected application in an automobile, said method comprising:
receiving data for the at least one user-selected application, via a communication interface;
identifying when the automobile is in a first operational mode, via at least one processor, wherein the automobile is in the first operational mode while the automobile is moving;
identifying when the automobile is in at least one second operational mode, via the at least one processor, wherein the automobile is in the at least one second operational mode when the automobile is stopped; and
executing the at least one user-selected application when the at least one second operational mode is identified such that a user of the automobile is enabled to access the at least one user-selected application during the at least one second operational mode.

16. A method in accordance with claim 15, comprising presenting the at least one user-selected application to the user, via a presentation interface.

17. A method in accordance with claim 15, wherein identifying when the automobile is in at least one second operational mode comprises identifying when the automobile is in at least one of a start mode, a stop mode, and a park mode.

18. A method in accordance with claim 17, wherein executing the at least one user-selected application comprises executing the at least one user-selected application when the automobile is in at least one of the start mode, the stop mode, and the park mode.

19. A method in accordance with claim 15, wherein identifying when the automobile is in a first operational mode comprises identifying when the automobile is in a driving mode.

20. A method in accordance with claim 19, comprising disabling the at least one user-selected application when the automobile is in the driving mode such that the user is unable to access the at least one user-selected application during the driving mode.
